(19) United States
(12) Patent Application Publication
(10) Pub. No.: US 2018/0059833 A1
(43) Pub. Date: Mar. 1, 2018

(54) TOUCH PANEL AND DISPLAY DEVICE USING THE SAME

(71) Applicant: PANASONIC INTELLECTUAL PROPERTY MANAGEMENT CO., LTD., Osaka (JP)

(72) Inventors: Shoji FUJII, Osaka (JP); Xiaofeng LU, Osaka (JP)

(21) Appl. No.: 15/526,490

(22) PCT Filed: Nov. 24, 2016
(86) PCT No.: PCT/JP2016/004948

§ 371 Date: May 12, 2017

(30) Foreign Application Priority Data
Dec. 25, 2015 (JP) 2015-253877

(51) Int. Cl. G06F 3/041; G02F 1/1333; G02F 1/1343

(52) U.S. Cl. CPC G06F 3/0412; G02F 1/1343; G02F 1/13338

(57) ABSTRACT

A touch panel has a first side and a second side opposite the first side. The first side has arithmetic average roughness between 0.06 micrometers and 0.13 micrometers, inclusive. The second side has arithmetic average roughness between 0.06 micrometers and 0.3 micrometers, inclusive.

### RELATED APPLICATIONS

This application is the U.S. National Phase under 35 U.S.C. §371 of International Patent Application No. PCT/JP2016/004948, filed on Nov. 24, 2016, which in turn claims the benefit of Japanese Application No. 2015-253877, filed on Dec. 25, 2015, the disclosures of which Applications are incorporated by reference herein.

### TECHNICAL FIELD

The present disclosure relates to a touch panel used to input data in various electronic devices, and to a display device.

### BACKGROUND ART

A conventional touch panel is described below. The conventional touch panel has a front side (a first side) and a back side (a second side). The back side is provided on the side opposite the front side. The back side of the touch panel is positioned facing a display. Light output from the display passes through the touch panel and becomes visible to an operator or the like. The front side of the touch panel is a display screen on which an image or the like output from the display is displayed, as well as is an operating face on which data is input by operator's finger contact or the like. Note that the back side of the touch panel may have projections and recesses. These projections and recesses have arithmetic average roughness Ra between 0.3 micrometers and 0.4 micrometers, inclusive.

Note that Patent Literature (PTL) 1, for example, is known as related art document information pertaining to the invention in the present application.

### CITATION LIST

### Patent Literature

PTL 1: Unexamined Japanese Patent Publication No. 2001-051262

### SUMMARY OF THE INVENTION

A touch panel has a first side and a second side on the side opposite the first side. The first side has arithmetic average roughness between 0.06 micrometers and 0.13 micrometers, inclusive. The second side has arithmetic average roughness between 0.06 micrometers and 0.3 micrometers, inclusive.

### BRIEF DESCRIPTION OF THE DRAWINGS

FIG. 1 is a schematic cross-sectional view of a display device according to an exemplary embodiment.

FIG. 2 is a schematic cross-sectional view of a touch panel according to an exemplary embodiment.

FIG. 3 is a schematic cross-sectional view of another touch panel according to an exemplary embodiment.

FIG. 4 is a schematic cross-sectional view of yet another touch panel according to an exemplary embodiment.

FIG. 5 is a schematic cross-sectional view of yet another touch panel according to an exemplary embodiment.

FIG. 6 is a schematic cross-sectional view of yet another touch panel according to an exemplary embodiment.

### DESCRIPTION OF EMBODIMENTS

The projections and recesses of the back side of a conventional touch panel have high arithmetic average roughness Ra between 0.3 micrometers and 0.4 micrometers, inclusive. In this case, light output from a display is concentrated on a specific region of the display screen (the front side) due to the lens effect of the projections and recesses of the back side of the touch panel. This increases variations in the luminance of the light on the display screen. As a result, the display screen of the touch panel shines with glaring light. This is called glare. This phenomenon is more likely to occur especially when a touch panel having a very uneven back side is provided on a high-resolution display. When a touch panel having a very slightly uneven back side is provided on a high-resolution display, however, reflection on the screen is more likely to occur.

Before description of a touch panel according to the present exemplary embodiment, a display and a display device will be described. Examples of the display include a liquid-crystal display (LCD) and an organic electroluminescent display (an organic EL display). These displays are required to be capable of displaying a high-definition image or be capable of displaying high-quality moving images that produce a powerful effect. Accordingly, the resolution of such displays has been increasing in recent years. In addition, a display device including such a high-resolution display and a touch panel has been increasingly mounted, for example, on a mobile device such as a smartphone or a tablet device. Furthermore, recent years have seen an increased use of such a display device in a moving device to input various instructions. An in-vehicle electronic device equipped with such a touch panel is, for example, a car navigation system.

The viewing angle for a mobile device can be adjusted by an operator changing the angle or the position of the mobile device. Therefore, there has been little need to consider the anti-glare feature (reflection). Thus, both the display screen and the back side of a touch panel mounted on such a mobile device have been smooth.

An electronic device such as that described above may, however, be embedded as an in-vehicle device in a predetermined position, for example, in a dashboard. In such a case, even when the sunlight or the like is reflected on the touch panel, it is difficult for an operator to adjust the installation angle, etc., of the electronic device to solve the reflection. Moreover, if the installation angle of the electronic device are adjustable, a driver would have to stop driving the moving device to adjust the installation angle of the electronic device. Thus, the touch panel mounted on the moving device is required to display a high-definition image on a glare-reduced, low-reflection screen (with an excellent anti-glare feature).

Display device 11 and touch panel 12 according to the exemplary embodiment are described below.

### EXEMPLARY EMBODIMENT

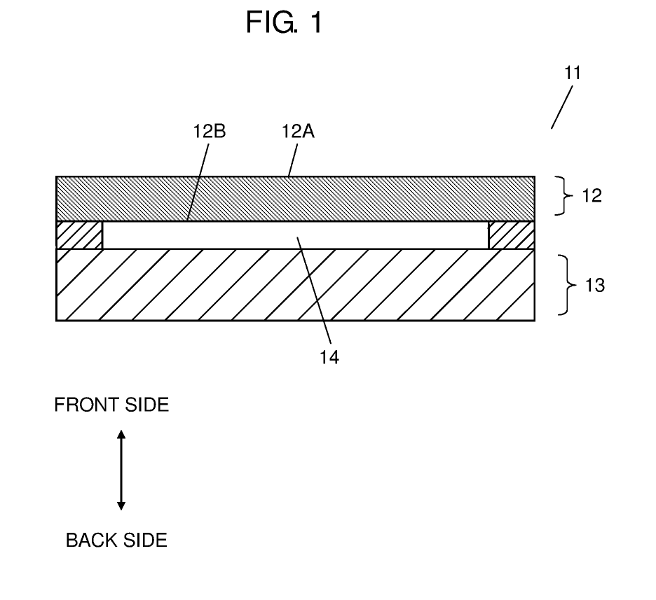

FIG. 1 is a schematic cross-sectional view of display device 11. Display device 11 includes touch panel 12 and display 13. Touch panel 12 is provided on the front side of display 13. Note that the front side of display 13 is a face from which light is emitted. Display 13 outputs red light, green light, and blue light frontward. Touch panel 12 is disposed relative to display 13 with gap 14 therebetween.

Touch panel 12 has front side 12A (a first side) and back side 12B (a second side). Back side 12B is provided on the side opposite front side 12A. Back side 12B is positioned facing the front side of display 13. Therefore, the light output from display 13 is incident on back side 12B of touch panel 12. Front side 12A is positioned in the most frontward area in display device 11. Back side 12B is positioned in the most backward area in touch panel 12. With this configuration, an operator (not illustrated in the drawings) can input an instruction to touch panel 12 by touching front side 12A with a finger or the like while looking at an image displayed on front side 12A. Thus, front side 12A is an input operating face of touch panel 12, as well as is a display screen of display device 11.

Front side 12A and back side 12B have projections and recesses. The projections and recesses of front side 12A preferably have arithmetic average roughness (Ra) between 0.06 micrometers and 0.13 micrometers, inclusive. The projections and recesses of front side 12A more preferably have arithmetic average roughness (Ra) between 0.08 micrometers and 0.11 micrometers, inclusive. The projections and recesses of back side 12B preferably have arithmetic average roughness (Ra) between 0.06 micrometers and 0.3 micrometers, inclusive. Note that the arithmetic average roughness (Ra) can be measured, for example, by the Surftest manufactured by Mitutoyo Corporation.

With the above configuration, the projections and recesses formed in front side 12A reduce the occurrence of reflection. Furthermore, the light radiated by display 13 is scattered by the projections and recesses of back side 12B. Therefore, it is possible to inhibit the light output from display 13 from being concentrated on a specific region. Thus, touch panel 12 is capable of reducing the occurrence of glare on the display screen. As a result, touch panel 12 is capable of inhibiting reflection and glare. In other words, display device 11 is capable of reducing the occurrences of reflection and glare even when high-resolution display 13 is used.

Hereinafter, display device 11 will be described in more detail. Display device 11 can be mounted on various electronic devices (not illustrated in the drawings). The electronic device is, for example, an in-vehicle car navigation system. Note that the electronic device is not limited to the car navigation system and may be a meter, etc., for displaying various data in an automobile, a car stereo, a television, or the like. Alternatively, the electronic device may be a cell phone, a smartphone, a tablet device, a personal computer, or the like. Furthermore, the electronic device may be a remote control.

Examples of display 13 include a liquid-crystal display (LCD) and an organic electroluminescent display (an organic EL display). Display 13 outputs light including red light, blue light, and green light from a large number of pixels. The number of pixels in display 13 having a high resolution is very large. Generally, when a high-definition image is displayed on display 13, the pixel density (resolution) of display 13 is preferably at least 100 dpi. For example, when a display having a pixel density of 400 dpi or more is used, glare is more likely to occur. Thus, the pixel density (resolution) of display 13 is preferably between 100 dpi and 200 dpi, inclusive.

The use of touch panel 12 having projections and recesses in front side 12A and back side 12B for display 13 can effectively inhibit reflection and glare. Furthermore, when gap 14 in display device 11 is in the range of 1 mm to 3 mm, glare tends to occur. However, the use of touch panel 12 having projections and recesses in front side 12A and back side 12B as in the present exemplary embodiment can effectively inhibit reflection and glare even for display device 11 having such gap 14.

The image clarity on touch panel 12 is preferably 20% or less. To be more specific, the image clarity on touch panel 12 is more preferably between 8% and 12%, inclusive. It is possible to improve the anti-glare feature of touch panel 12 by setting the value of the image clarity within this range. Note that the image clarity is measured in accordance with JIS K 7374. The image clarity can be measured, for example, by the image clarity meter ICM-1T manufactured by Suga Test Instruments Co., Ltd.

The value of standard deviation of luminance per unit area when touch panel 12 is viewed from front side 12A is preferably less than 20. With this configuration, it is possible to reduce a sense of discomfort or incongruity which an operator looking at a displayed image would feel due to glare. The luminance per unit area can be measured by a two-dimensional luminance meter. A light source is provided behind back side 12B of touch panel 12, and the luminance per unit area can be measured by measuring luminance within the screen while the light source emits light. Note that a 400 dpi EL display is used as the light source. The luminance per unit area can be measured, for example, by a two-dimensional luminance meter manufactured by Komatsu NTC Ltd.

The distance between front side 12A and back side 12B is preferably between 2 mm and 4 mm, inclusive. It is possible to effectively inhibit reflection and glare by setting the distance between front side 12A and back side 12B within this range.

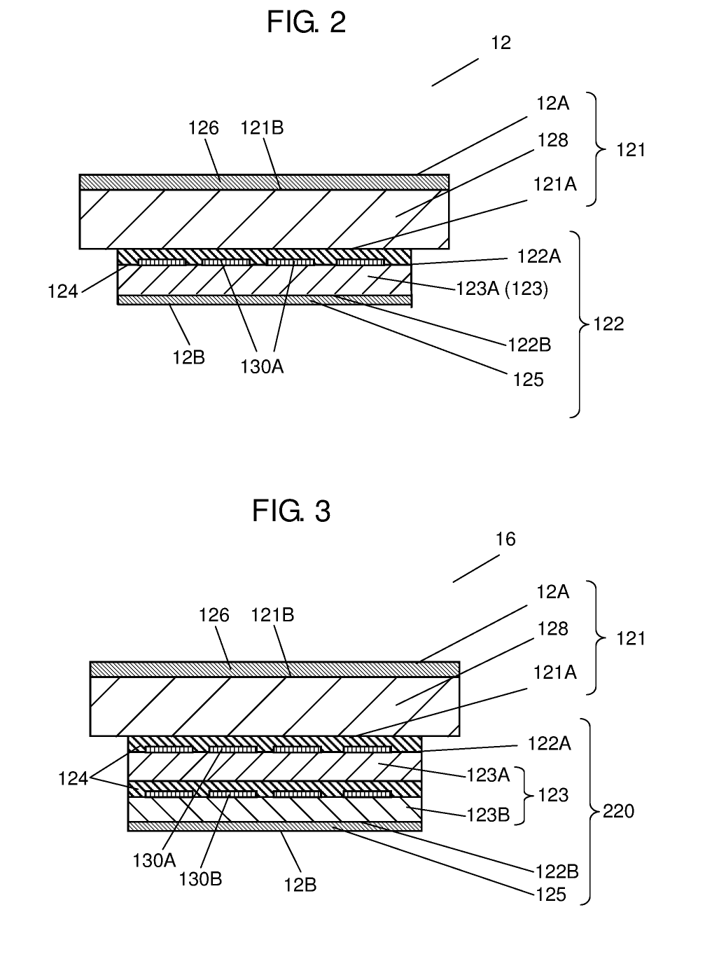

Next, the configuration of touch panel 12 will be described in more detail. FIG. 2 is a schematic cross-sectional view of touch panel 12. Touch panel 12 includes cover lens 121 made of a resin and main layer 122. Cover lens 121 has front side 12A and smooth side 121A (a first smooth side). Note that front side 12A is formed on the side opposite smooth side 121A. Main layer 122 has smooth side 122A (a second smooth side) and back side 12B. Note that back side 12B is formed on the side opposite smooth side 122A. Smooth side 121A is positioned facing smooth side 122A, and cover lens 121 and main layer 122 are bonded together with adhesive material 124. In other words, touch panel 12 is a laminate of cover lens 121 and main layer 122. Cover lens 121 includes substrate 128. Front side 12A and smooth side 121A are formed on both sides of substrate 128.

Main layer 122 includes sensor electrode layer 123 on which sensor electrode 130A is formed. Smooth side 122A and back side 12B are formed on both sides of sensor electrode layer 123. Sensor electrode layer 123 is formed of film 123A made of a resin. Sensor electrode 130A on film 123A is located on the front side of sensor electrode layer 123. In other words, sensor electrode 130A is formed on smooth side 122A (the second smooth side) of main layer 122.

The thickness of film 123A is preferably between 20 micrometers and 200 micrometers, inclusive. A highly light-transmissive resin for optical use is preferably used as film 123A. For example, a polyester-based resin, a polycarbonate-based resin, or a polyolefin-based resin can be used as film 123A.

Main layer 122 may include uneven layer 125. Furthermore, cover lens 121 may include uneven layer 126. In this case, one side of uneven layer 125 is back side 12B. And one side of uneven layer 126 is front side 12A. In other words, uneven layer 125 and uneven layer 126 form projections and recesses in main layer 122 and cover lens 121. In this case, main layer 122 has smooth side 122B on the side opposite smooth side 122A. Meanwhile, cover lens 121 has smooth side 121B on the side opposite smooth side 121A. In other words, smooth side 121B is formed on the front side of cover lens 121. Smooth side 122B is formed on the back side of sensor electrode layer 123. Uneven layer 126 is formed on smooth side 121B. Uneven layer 125 is formed on smooth side 122B.

Uneven layer 125 and uneven layer 126 can each be formed, for example, using a resin containing a filler. In this case, the resin containing the filler is applied to smooth side 122B or smooth side 121B to form uneven layer 125 or uneven layer 126. At that time, the size, etc., of the filler is adjusted, allowing front side 12A and back side 12B with projections and recesses having desired arithmetic average roughness to be formed on touch panel 12. As the filler, SiO₂ or the like is used, for example. As the resin, an acrylic resin or the like is used, for example.

Average distance Sm (Rsm) between the projections and recesses of uneven layer 125 is preferably between 0.02 mm and 0.3 mm, inclusive. Uneven layer 125 preferably has, as optical properties thereof, a haze (Hz) between 5% and 15%, inclusive, and transmittance of at least 85%. With this configuration, it is possible to reduce glare to such an extent that it does not hinder the operation by an operator. Average distance Sm is the average length of roughness curve elements based on JIS B 0601: 1994, which is referred to as average distance Rsm in JIS B 0601: 2013.

Meanwhile, average distance Sm (Rsm) between the projections and recesses of uneven layer 126 is preferably between 0.05 micrometers and 0.15 micrometers, inclusive. Uneven layer 126 preferably has, as optical properties thereof, a haze (Hz) between 1% and 10%, inclusive, and transmittance of at least 70%. With this configuration, it is possible to reduce the occurrence of reflection.

Uneven layer 125 and uneven layer 126 may each be configured to include an antireflection film (not illustrated in the drawings) on the side from which the projections and recesses are exposed. With this configuration, it is possible to further reduce the occurrence of reflection. Alternatively, uneven layer 126 may be configured to include a lipophilic or lipophobic fingerprint-proof treatment layer (not illustrated in the drawings) on the side on which the projections and recesses are located. With this configuration, fingerprint smudges on the display screen can be reduced when an operator inputs data by touching the display screen with a finger.

Uneven layer 125 may be configured to include a lipophilic or lipophobic fingerprint-proof treatment layer (not illustrated in the drawings) on the side from which the projections and recesses are exposed. With this configuration, fingerprint smudges on back side 12B can be reduced, for example, during assembly of display device 11.

The thickness of adhesive material 124 is preferably between 20 micrometers and 150 micrometers, inclusive. A highly light-transmissive resin for optical use is preferably used as adhesive material 124. As adhesive material 124, an acrylic adhesive material can be used, for example.

In order to confirm the glare-inhibiting and reflection-inhibiting effect due to the arithmetic average roughness of front side 12A, the arithmetic average roughness of back side 12B, and a combination thereof, the inventors created the following samples. Specifically, the arithmetic average roughness of back side 12B is set to approximately 0.05 micrometers, 0.3 micrometers, 0.06 micrometers, and 0.03 micrometers. The samples are created by changing the arithmetic average roughness of front side 12A with each of such back sides to 0.04 micrometers, 0.06 micrometers, 0.08 micrometers, 0.11 micrometers, 0.13 micrometers, and 0.15 micrometers.

### Comparative Example 1

The back side is smooth (Table 1).

### Comparative Example 2

The projections and recesses of the back side have arithmetic average roughness of 0.5 micrometers (Table 2).

### Working Example 1

The projections and recesses of the back side have arithmetic average roughness of 0.3 micrometers (Table 3).

### Working Example 2

The projections and recesses of the back side have arithmetic average roughness of 0.06 micrometers (Table 4).

### Comparative Example 3

The projections and recesses of the back side have arithmetic average roughness of 0.03 micrometers (Table 5).

As mentioned above, 30 samples different in the arithmetic average roughness of front side 12A and the arithmetic average roughness of back side 12B are created, and Table 1 to Table 5 show the measurement results of the image clarity (reflection) and variations in the luminance per unit area (glare). The unit of glare is Cd/m².

TABLE 1

| Front | Back | | | | | |
|---|---|---|---|---|---|---|
| side | side | | | | | |
| Ra | Ra | Glare | Glare | Reflection | | Overall |
| (μm) | (μm) | (cd/m²) | (cd/m²) | (%) | Reflection | rating |
| 0.04 | — | 6 | E | 47 | N | N |
| 0.06 | — | 9 | E | 30 | N | N |
| 0.08 | — | 30 | N | 12 | E | N |
| 0.11 | — | 45 | N | 10 | E | N |
| 0.13 | — | 50 | N | 10 | E | N |
| 0.15 | — | 50 | N | 6 | E | N |

TABLE 2

| Front | Back | | | | | |
|---|---|---|---|---|---|---|
| side | side | | | | | |
| Ra | Ra | Glare | Glare | Reflection | | Overall |
| (μm) | (μm) | (cd/m²) | (cd/m²) | (%) | Reflection | rating |
| 0.04 | 0.5 | 24 | N | 53 | N | N |
| 0.06 | 0.5 | 27 | N | 36 | N | N |
| 0.08 | 0.5 | 21 | N | 18 | E | N |
| 0.11 | 0.5 | 22 | N | 19 | E | N |
| 0.13 | 0.5 | 40 | N | 17 | E | N |
| 0.15 | 0.5 | 45 | N | 10 | E | N |

TABLE 3

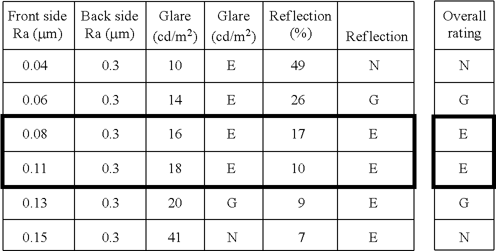

TABLE 4

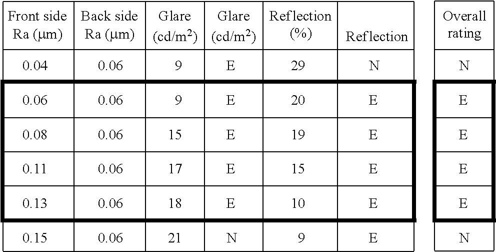

TABLE 5

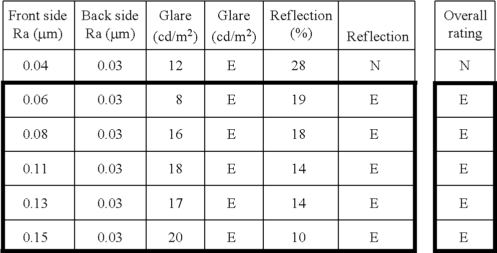

In Table 1 to Table 5, samples having very good properties are rated as E (Excellent), samples having good properties are rated as G (Good), and samples having poor properties are rated as N (No Good).

As illustrated in Table 1, the evaluation result of the samples in comparative example 1 shows that when the front side has low arithmetic average roughness, reflection occurs. Furthermore, when the front side has high arithmetic average roughness, the occurrence of glare cannot be reduced. This shows that when the back side is smooth, glare and reflection cannot be inhibited simultaneously. As illustrated in Table 2, the evaluation result of the samples in comparative example 2 shows that the occurrence of glare cannot be reduced. As illustrated in Table 5, the evaluation result of the samples in comparative example 3 shows that in samples other than those having front side 12A with arithmetic average roughness of 0.04 micrometers, the occurrences of glare and reflection can be reduced. It is, however, found that in the samples in comparative example 3, the arithmetic average roughness of back side 12B is too low, making text blurry.

As shown in working example 1 in Table 3, in the case where back side 12B has arithmetic average roughness of 0.3 micrometers, glare and reflection can be inhibited when the arithmetic average roughness of front side 12A is between 0.08 micrometers and 0.11 micrometers. In the cases where front side 12A has arithmetic average roughness of 0.06 micrometers and 0.13 micrometers, relatively good results are obtained.

As shown in working example 2 in Table 4, in the case where back side 12B has arithmetic average roughness of 0.06 micrometers, glare and reflection can be inhibited when front side 12A has arithmetic average roughness between 0.06 micrometers and 0.13 micrometers.

According to the above evaluation, good properties are obtained when front side 12A has arithmetic average roughness between 0.06 micrometers and 0.13 micrometers, inclusive, and back side 12B has arithmetic average roughness between 0.06 micrometers and 0.3 micrometers, inclusive.

Very good properties are obtained when front side 12A has arithmetic average roughness between 0.08 micrometers and 0.11 micrometers, inclusive, and back side 12B has arithmetic average roughness between 0.06 micrometers and 0.3 micrometers, inclusive.

Note that sensor electrode layer 123 is not limited to being formed of film 123A and may be formed of film 123A made of a resin and film 123B made of a resin, as illustrated in FIG. 3. FIG. 3 is a schematic cross-sectional view of another touch panel 16 according to the exemplary embodiment. Touch panel 16 includes main layer 220 instead of main layer 122 in touch panel 12 illustrated in FIG. 2. In this case, film 123A and film 123B are bonded together with adhesive material 124. Both sensor electrode 130A on film 123A and sensor electrode 130B on film 123B are located on the front side. In this case, sensor electrode 130A on film 123A is capable of detecting a point in a line orthogonal to the direction of detection by sensor electrode 130B on film 123B. The thickness of each of film 123A and film 123B is preferably between 20 micrometers and 200 micrometers, inclusive. A highly light-transmissive resin for optical use is preferably used as each of film 123A and film 123B. For example, a polyester-based resin, a polycarbonate-based resin, or a polyolefin-based resin can be used as each of film 123A and film 123B.

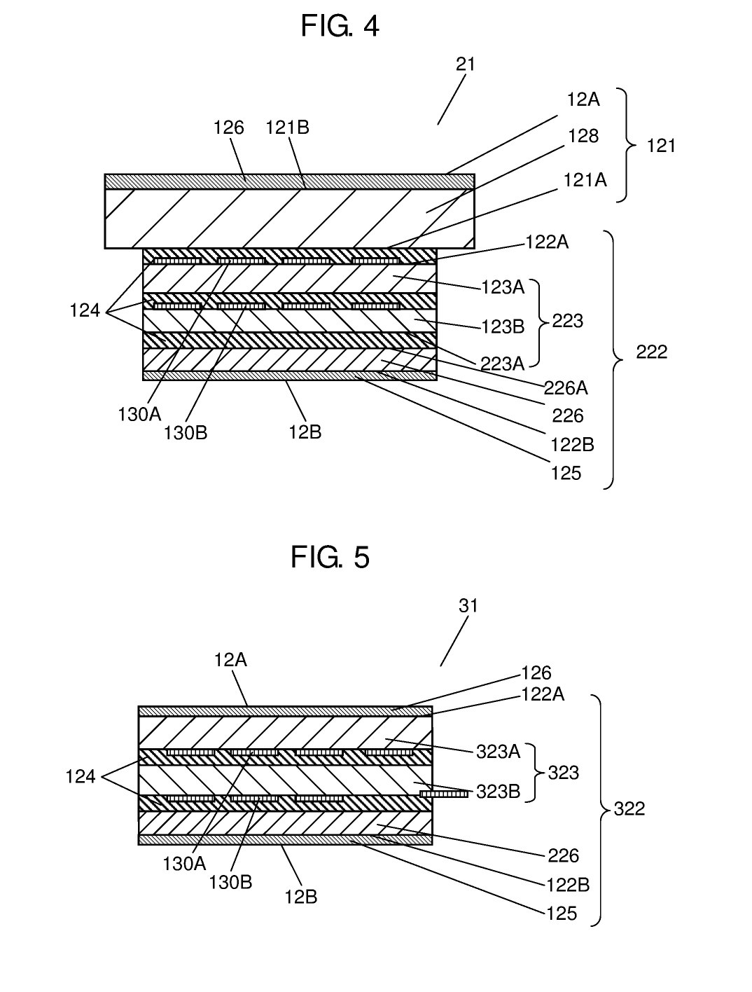

FIG. 4 is a schematic cross-sectional view of touch panel 21. Touch panel 21 includes main layer 222 instead of main layer 122 in touch panel 12 illustrated in FIG. 2. Main layer 222 includes sensor electrode layer 223 (a sensor electrode body) and film layer 226. In this case, film layer 226 has back side 12B with projections and recesses. Main layer 222 is a laminate of sensor electrode layer 223 and film layer 226. Sensor electrode layer 223 has smooth side 223A instead of smooth side 122B of sensor electrode layer 123 illustrated in FIG. 2. In other words, smooth side 223A is formed on the side opposite smooth side 122A.

The projections and recesses of film layer 226 may be formed by uneven layer 125. In this case, film layer 226 has smooth side 122B on the back side. Furthermore, film layer 226 has smooth side 226A on the side opposite smooth side 122B. Note that smooth side 226A is positioned facing smooth side 223A. Smooth side 226A and smooth side 223A are bonded together with adhesive material 124. Film layer 226 may be, for example, a polarizer. With this configuration, it is possible to reduce surface reflection, improving display visibility.

FIG. 5 is a schematic cross-sectional view of touch panel 31. Touch panel 31 does not include cover lens 121 or adhesive material 124, which is provided between cover lens 121 and main layer 222, included in touch panel 21 illustrated in FIG. 4. Touch panel 31 includes main layer 322 instead of main layer 222 illustrated in FIG. 4. Main layer 322 includes sensor electrode layer 323 and film layer 226. Main layer 322 has front side 12A. Specifically, uneven layer 126 is formed on the front side of sensor electrode layer 323.

Main layer 322 includes film 323A and film 323B. Note that film 323A and film 323B are bonded together with adhesive material 124. In this case, sensor electrodes 130A and 130B are laid out on the back sides of film 323A and film 323B.

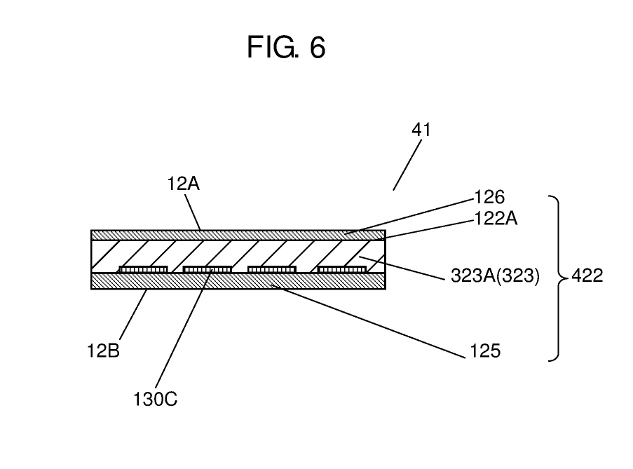

FIG. 6 is a schematic cross-sectional view of touch panel 41. Main layer 422 of touch panel 41 includes sensor electrode layer 323. Sensor electrode layer 323 is formed of film 323A. Uneven layer 126 is formed on the front side of sensor electrode layer 323. Uneven layer 125 is formed on the back side of sensor electrode layer 323. Main layer 422 has front side 12A and back side 12B. In other words, in touch panel 41, uneven layers are formed on upper and lower sides of a single electrode layer. Furthermore, sensor electrode 130C is formed in a depression (a recess) of sensor electrode layer 323, rather than on a surface of sensor electrode layer 323. Glare and reflection can be inhibited not only with the configuration illustrated in FIG. 2, but also with the configurations illustrated in FIG. 3 to FIG. 6.

As described above, according to the present disclosure, when the back side is positioned facing the display, light can be scattered by the back side. Therefore, by the lens effect of the projections and recesses of the front side, it is possible to reduce the occurrence of the light output from the display being concentrated on a specific region. The projections and recesses of the front side also makes it possible to reduce the occurrence of reflection. As a result, glare and reflection can be inhibited. Thus, it is possible to provide a touch panel usable for a high-resolution display.

### INDUSTRIAL APPLICABILITY

A touch panel according to the present disclosure has the effect of inhibiting reflection and preventing glare and is useful, particularly, in an electronic device, etc., to be mounted on a moving device such as an automobile.

### REFERENCE MARKS IN THE DRAWINGS

11 display device
12 touch panel
12A front side (first side)
12B back side (second side)
13 display
14 gap
16 touch panel
21 touch panel
31 touch panel
41 touch panel
121 cover lens
121A smooth side
121B smooth side
122 main layer
122A smooth side
122B smooth side
123 sensor electrode layer
123A film
123B film
124 adhesive material
125 uneven layer
126 uneven layer
128 substrate
130A, 130B, 130C sensor electrode
220 main layer
222 main layer
223 sensor electrode layer
223A smooth side
226 film layer
226A smooth side
322 main layer
323 sensor electrode layer
323A film
323B film
422 main layer

1. A touch panel, comprising:
a first side; and
a second side opposite the first side, wherein
the first side has arithmetic average roughness between 0.06 micrometers and 0.13 micrometers, inclusive, and
the second side has arithmetic average roughness between 0.06 micrometers and 0.3 micrometers, inclusive.

2. The touch panel according to claim 1, wherein
the arithmetic average roughness of the first side is greater than or equal to the arithmetic average roughness of the second side.

3. The touch panel according to claim 1, comprising:
a cover lens made of a resin and having the first side as one side and a first smooth side opposite the first side; and
a main layer having a second smooth side bonded to the first smooth side and the second side opposite the second smooth side.

4. The touch panel according to claim 3, wherein
the main layer is formed of a resin, and a sensor electrode is formed on the second smooth side of the main layer.

5. The touch panel according to claim 3, wherein
the main layer includes:
a third smooth side opposite the second smooth side; and
an uneven layer which is provided on the third smooth side and on which the second side is formed.

6. The touch panel according to claim 5, wherein
the uneven layer is formed using a resin containing a filler.

7. The touch panel according to claim 3, wherein
the main layer is formed by stacking two films each made of a resin and including a sensor electrode.

8. The touch panel according to claim 3, wherein
the main layer is a laminate of:
a sensor electrode body formed by stacking two films each made of a resin and including a sensor electrode; and
a film layer.

9. The touch panel according to claim 8, wherein
the film layer is a polarizer.

10. The touch panel according to claim 1, wherein
image clarity measured in accordance with JIS K 7374 is between 8% and 12%, inclusive, and a value of standard deviation of luminance when the touch panel is viewed from the first side is less than 20.

11. The touch panel according to claim 1, wherein
a distance between the first side and the second side is between 2 mm and 4 mm, inclusive.

12. A display device, comprising:
a touch panel having a first side having arithmetic average roughness between 0.06 micrometers and 0.13 micrometers, inclusive, and a second side opposite the first side and having arithmetic average roughness between 0.06 micrometers and 0.3 micrometers, inclusive; and
a display positioned facing the second side of the touch panel with a gap between the display and the second side of the touch panel.

13. The display device according to claim 12, wherein
the first side has arithmetic average roughness between 0.08 micrometers and 0.11 micrometers, inclusive.

14. The display device according to claim 12, wherein
the gap is between 1 mm and 3 mm, inclusive.

15. The display device according to claim 12, wherein
the display has a resolution between 100 dpi and 200 dpi, inclusive.
